(19) United States
(12) Patent Application Publication
(10) Pub. No.: US 2008/0182046 A1
(43) Pub. Date: Jul. 31, 2008

(54) Process for the production of a composite structural component

(76) Inventors: Roland Brambrink, Ratingen (DE); Hans-Jorg Dahmen, Duisburg (DE); Winfried Kohl, Isando (ZA); Olaf Zollner, Leverkusen (DE)

Correspondence Address: BAYER MATERIAL SCIENCE LLC, 100 BAYER ROAD, PITTSBURGH, PA, 15205, US

(21) Appl. No.: 11/483,889

(22) Filed: Jul. 10, 2006

(30) Foreign Application Priority Data
Jul. 13, 2005 (DE) 102005032664.1

(51) Int. Cl. B29C 45/16; E06B 3/66

(52) U.S. Cl. 428/34; 264/261; 264/138; 264/135; 264/132; 264/250

(57) ABSTRACT

A method of forming a multi-component molded article is described. The method includes first introducing a first plastic film and a second plastic film separately into a first cavity of an injection mold, the first and said second plastic films each being positioned within the first cavity so as to form a void there-between. Next, a first thermoplastic material is injected into the void, thereby forming a first molding. The first molding is then released from the mold, and the first molding and at least one second molding are together introduced into a second cavity of the mold. Finally, a second thermoplastic material is injected into the second cavity of the mold, thereby combining the first molding and second molding together thus forming a multi-component molded article.

### CROSS REFERENCE TO RELATED PATENT APPLICATION

The present patent application claims the right of priority under 35 U.S.C. § 119 (a)-(d) of German Patent Application No. 10 2005 032 664.1 filed Jul. 13, 2005, which is incorporated herein by reference in its entirety.

### FIELD OF THE INVENTION

The invention relates to a process for the production of a composite structural component by means of injection molding or compression injection molding.

### BACKGROUND OF THE INVENTION

Optical structural components, e.g. window panes in motor vehicle construction, are made predominantly of glass because they have very good surface properties, e.g. a high scratch resistance. These structural components involve high material costs and have a low integration potential. This means that a considerable effort is required to combine these structural components with other moldings.

It is already known, however, to produce optical structural elements from transparent thermoplastic. These are not only lighter and more convenient, but can also be combined much more easily with other moldings, such as metal or plastic components. However, the scratch resistance of surfaces of transparent thermo-plastic has to be increased by a protective layer of e.g. lacquer.

According to the state of the art, such composite structural components made of an optical molding of transparent thermoplastic are produced by laborious processes in several separate steps and in several separate devices. For example, first of all a sheet of transparent plastic is produced by injection molding. The sheet is then coated with a suitable lacquer to increase the scratch resistance of its surfaces. In a third step the coated sheet is provided with a seal, for example, in another injection mold or combined with another molding, such as a guide rail.

### SUMMARY OF THE INVENTION

The object of the present invention is to provide a process for the production of a composite structural component which at least consists of a plastic molding coated on both sides with a film, and another molding. The process should be as simple as possible and executable in a small number of steps.

In accordance with the present invention, there is provided a process for the production of a composite structural component, comprising:
(a) introducing (or positioning) a first plastic film and a second plastic film into a first cavity of an injection mold, said first plastic film and said second plastic film being positioned within said first cavity so as to form a void between said first plastic film and said second plastic film;
(b) injecting a first thermoplastic material (preferably in a molten state) into said void, thereby forming a first molding;
(c) releasing said first molding formed in step (b) from said first mold cavity, and
   introducing said first molding and at least one second molding into a second cavity of the same or another injection mold; and
(d) injecting a second thermoplastic material (preferably in a molten state) into said second cavity, thereby combining said first molding and said second molding (e.g., said first molding and said second molding being fixedly attached one to the other by means of the injected second thermoplastic material, and together with the second thermoplastic material forming a multi-component molded article).

### DETAILED DESCRIPTION OF THE INVENTION

The process according to the invention is carried out in an injection mold having at least two cavities. Within the framework of the present invention, the expressions “injection molding” and “injection mold” are used by way of simplification, but they include compression injection molding and compression injection mold.

In a preferred embodiment the first molding is only back-moulded in its edge region with the second thermoplastic material in step (d) in the second cavity, so that a transparent window region remains in the first molding.

The first and second films are preferably transparent and are preferably made of polycarbonate (PC), polymethyl methacrylate (PMMA) or a polycarbonate/poly-methyl methacrylate blend. The two films can be made either of the same plastic or of different plastics. The films preferably have a thickness of 0.1 to 1 mm.

In one preferred embodiment of the process, before they are introduced into the injection mold according to step (a), the first and second films are shaped, cut, coated and/or printed. Preferably, the first and second films are coated with a lacquer or a layer of PMMA. Hard coat lacquers, e.g. siloxane lacquers or UV-curable lacquers, are particularly suitable. Film coating processes are known from the state of the art. The coating of the first and second films with a layer of PMMA can be effected e.g. by coextrusion. Lacquers can be applied e.g. by spraying. Depending on the type of coating, it may no longer be possible to shape the films after coating, so shaping has to take place before coating. Shaping is effected e.g. by deep drawing. Prior to coating and deep drawing, the films can additionally be printed with screen printing inks.

The first and second films are each introduced into a first cavity of an injection mold according to step (a). They are each introduced in such a way as to be kept apart in the cavity. The two films may be fixed in the cavity in a manner known from the state of the art, e.g., mechanically, electrostatically or by means of vacuum. The first film and/or the second film may each be independently positioned within the first cavity of the mold so as to abut the internal surfaces (e.g., separate internal surfaces) of the mold (e.g., the first film abutting at least a portion of the internal surface of a first mold half, and the second film abutting at least a portion of the internal surface of a second mold half). Alternatively, the first film and/or the second film may each be independently positioned within the first cavity of the mold so as not to abut the internal surfaces of the mold. Further alternatively, a combination of such abutting and non-abutting relationships with the internal surfaces of the mold may be employed when positioning the first film and the second film in the first cavity of the mold, in the method of the present invention.

The first and second films may be arranged substantially parallel to one another, for example. The gap between the first and second films creates (or forms) a void in the first cavity of the mold, into which a first thermoplastic material is injected in step (b). This results in the formation of a first molding, which is subsequently released according to step (c).

In principle, the first molding may have any desired shape. For example, the first molding may have the shape of a sheet, plate or pot, it being possible for the sheet or plate to be flat, bowed or bent, for example. The first molding may have the same thickness over its entire area, or it can have different thicknesses in different regions. To produce a molding in the shape of a sheet, the thickness of the molded sheet may be, for example, 3 to 6 mm.

The first thermoplastic material is preferably a transparent plastic and particularly preferably a polycarbonate (PC), polymethyl methacrylate (PMMA), transparent polyamide (PA) and/or cycloolefin copolymer (COC). However, any other thermoplastic material suitable for injection molding or compression injection molding may also be used to form a non-transparent first molding.

After release, the first molding is then introduced into a second cavity of the injection mold (in step (c)). The first molding may be transferred by known methods, such as those used in multi-color injection molding methods. On the one hand, typical methods of transfer that may be used in the present method, include transfer by means of a rotary table, turnover board, sliding cavity or index plate, or comparable methods in which the first molding remains on the core. On the other hand, methods of transferring a molding in the method of the present invention further include, those art-recognized methods in which the molding is removed from one cavity (e.g., with the aid of a handling system) and placed in another cavity.

In addition, at least one second molding is introduced into the second cavity. The second molding can be any desired plastic and/or metal molding. If the first molding is a transparent sheet, e.g. as used in motor vehicle construction, the second molding may be a guide rail made of steel, aluminum, polyamide, especially filled polyamide, or polycarbonate.

The first and second moldings are combined (e.g., fixedly attached to each other) by injecting a second thermoplastic material into the second cavity of the injection mold. The second thermoplastic material may be selected from, for example, thermoplastic polyurethane (TPU), thermoplastic polyethylene (TPE), polycarbonate (PC), PC blends and/or polyvinylchloride (PVC) or one of the abovementioned transparent plastics or a mixture of these plastics.

The invention also relates to plastic windows obtained by the process according to the invention and their use for the manufacture of vehicles such as for example motor vehicles, ships or aeroplanes, or for household appliances.

The invention is exemplified in more detail in the figures:

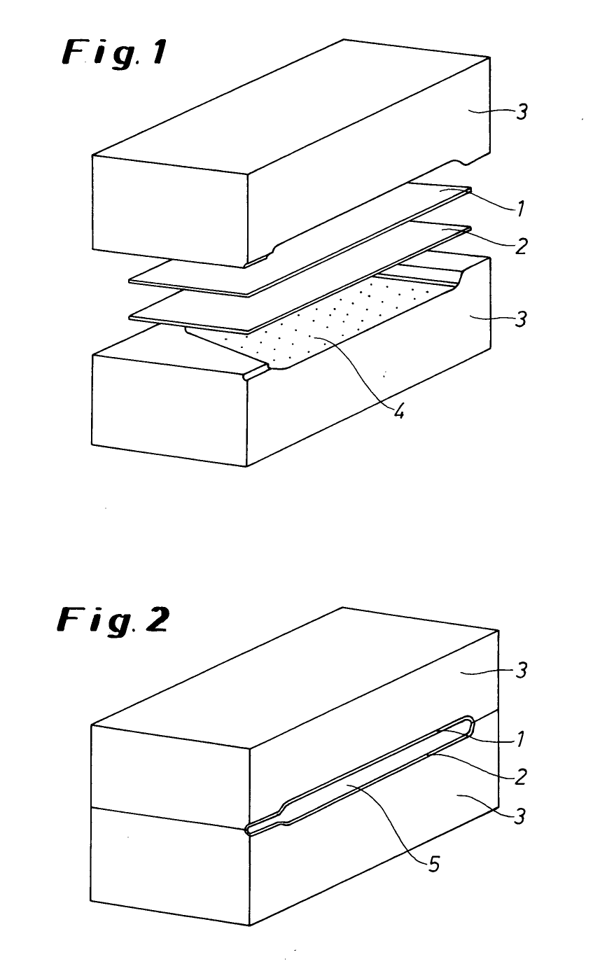

FIG. 1 depicts the open mold

FIG. 2 depicts the closed mold containing the film

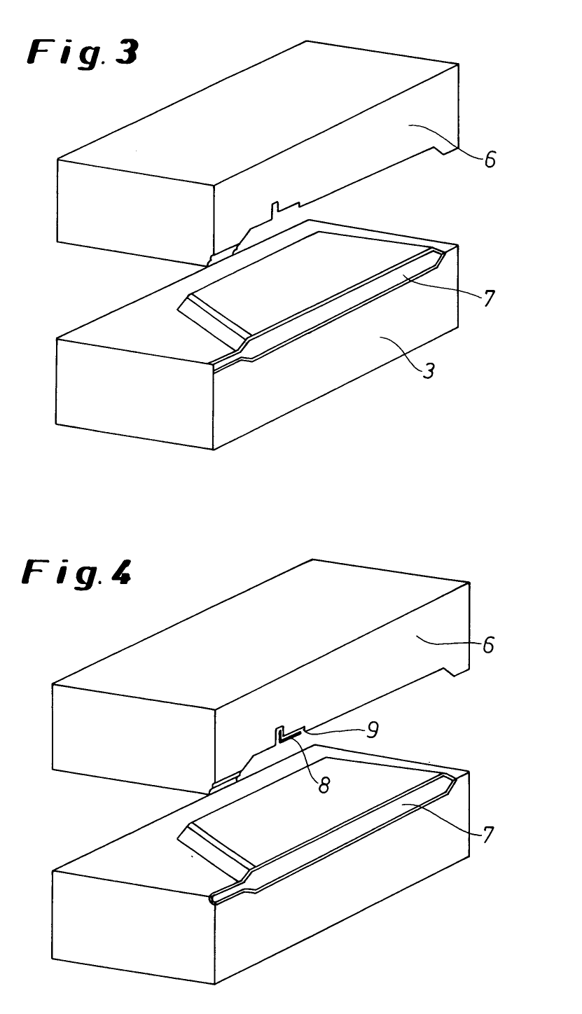

FIG. 3 depicts the supply of a second mold half

FIG. 4 depicts the insertion of a bracket 8

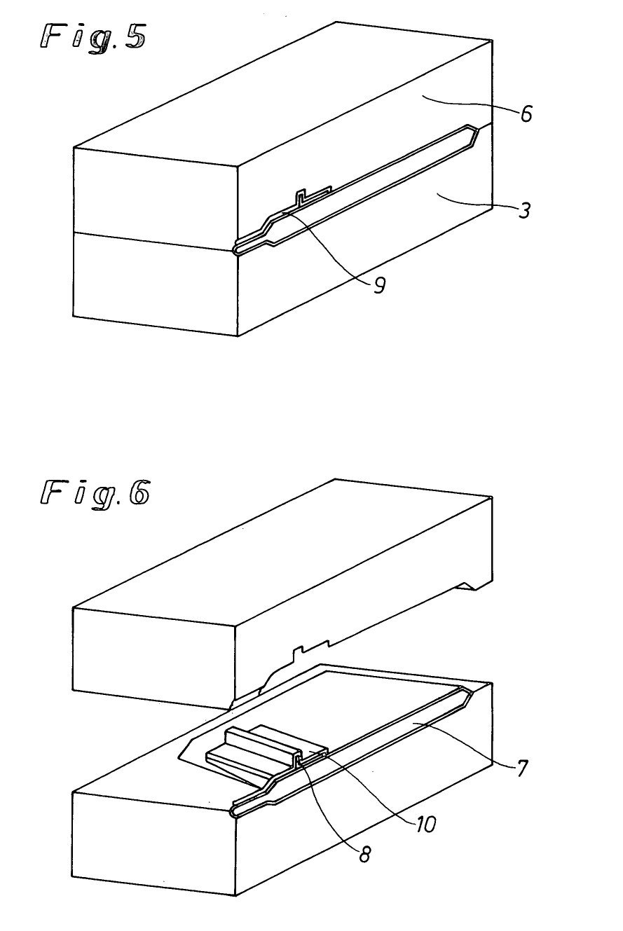

FIG. 5 depicts the closing of the mold halves and

FIG. 6 depicts the opened mold halves and the injected-on second plastic.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

### EXAMPLE

The following example describes the production of a partially transparent structural component which is stiffened by means of a metal insert and is protected against scratches on its surface by externally applied films. The metal insert can be used not only for stiffening purposes but also as a local reinforcement for the screwing attachment of mounted parts.

In a first working step a film based on PC (polycarbonate) is coextruded with a layer of PMMA (polymethyl methacrylate). In order to insert the film into a three-dimensionally shaped mold cavity it can either be pre-shaped in a deep-drawing process and cut or directly brought into the corresponding shape by the injection-molding process.

The first (1) and second (2) co-extruded films are introduced into the opened halves (3) of the injection mold as shown in FIG. 1. In this instance the films are flat and not pre-shaped. A vacuum is produced via small holes (4) in the mold. This vacuum presses the films into the cavity of the mold and fixes them in place.

The injection mold is closed by pressing the two mold halves (3) against each other (FIG. 2). A void (5) is produced between the films which is filled by injecting in a PC (polycarbonate) thermoplastic material. The thickness of the panel thus produced is 5 mm.

The mold needs a new cavity for the metal bracket to be inserted in the next working step. This new cavity is positioned on a so-called rotatable plate which is rotated about its vertical axis by 180° in order to move away the old cavity and place the new cavity (6) in position (FIG. 3). The previously injection-molded panel (7) remains in the mold half (3) on the nozzle side.

In FIG. 4 a handling system now places a metal bracket (8) in the new cavity (6). This cavity must be shaped in such a manner that a gap (9) of a height of 2.5 mm is present between the wall of the cavity (6) and the metal insert.

The two mold halves (3) and (6) are once against pressed against each other (FIG. 5). A second thermoplastic component is injected into gap 9, for which the material used is a PC/PET blend. The second thermoplastic component (10) can be seen in FIG. 6. This component (10) completely envelops the metal insert (8) and forms a very firm bond with the underlying injection-molded panel (7).

What is claimed is:

1. A process for the production of a composite structural component, comprising:
(a) introducing a first plastic film and a second plastic film into a first cavity of an injection mold, said first plastic film and said second plastic film being positioned within said first cavity so as to form a void between said first plastic film and said second plastic film;
(b) injecting a first thermoplastic material into said void, thereby forming a first molding;
(c) releasing said first molding formed in step (b), and introducing said first molding and at least one second molding into a second cavity of the same or another injection mold; and
(d) injecting a second thermoplastic material into said second cavity, thereby combining said first molding and said second molding.

2. The process of claim 1 further comprising, prior to step (a), subjecting at least one of said first film and said second film to a process selected from the group consisting of shaping, cutting, coating, printing and combinations thereof.

3. The process of claim 1 wherein said first film and said second film are each independently fabricated from a material selected from the group consisting of polycarbonate, polymethyl methacrylate and polycarbonate/polymethyl methacrylate blends.

4. The process of claim 1 wherein said first thermoplastic material is transparent.

5. The process of claim 4 wherein said first thermoplastic material is selected from the group consisting of polycarbonate, polymethyl methacrylate, polyamide, cycloolefin copolymer and combinations thereof.

6. The process of claim 1 wherein said second molding is fabricated from a material selected from the group consisting of plastic, metal and combinations thereof.

7. The process of claim 1 wherein said second thermoplastic material is selected from the group consisting of thermoplastic polyurethane, thermoplastic polyethylene, polycarbonate, polyvinylchloride, polycarbonate blends, polymethylmethacrylate, polyamide, cycloolefin copolymer and combinations thereof.

8. The process of claim 1, wherein in step (d) in the second cavity the second thermoplastic material is injection-molded around the edge region of the first molding, thereby obtaining a transparent window in the first molding.

9. A plastic window produced according to one of claim 1.
